(19) United States
(12) Patent Application Publication
(10) Pub. No.: US 2025/0271507 A1
(43) Pub. Date: Aug. 28, 2025

(54) REMAINING LIFETIME ESTIMATION METHOD FOR ELECTRONIC POWER CONVERTERS

(71) Applicant: PRODRIVE TECHNOLOGIES INNOVATION SERVICES B.V., Son en Breugel (NL)

(72) Inventors: Joost Johan VAN STRAALEN, Son en Breugel (NL); Junnan XU, Son en Breugel (NL)

(21) Appl. No.: 18/859,443

(22) PCT Filed: Apr. 25, 2023
(86) PCT No.: PCT/EP2023/060748

§ 371 Date: Oct. 23, 2024

(30) Foreign Application Priority Data
Apr. 29, 2022 (NL) 2031746

(51) Int. Cl. G01R 31/40; H02M 1/32

(52) U.S. Cl. CPC G01R 31/40; H02M 1/327

(57) ABSTRACT

A method is disclosed for estimating an accumulated fatigue damage of a switching power converter. The switching power converter has power modules each including a first semiconductor device. The method includes determining of the plurality of power modules, a single power module having the first semiconductor device being thermally most heavily stressed. During operation of the switching power converter, a reference temperature is measured related to a temperature of at least the single power module. A current of the switching power converter is determined, particularly a current representative of a power dissipation through the first semiconductor device. A single fatigue damage of the first semiconductor device of the single power module is calculated based at least on the current and the reference temperature. A switching power converter may have a processing unit configured to implement the above method.

### TECHNICAL FIELD

The present disclosure relates to a method for estimating a remaining lifetime for an electronic power converter, such as an amplifier. The present disclosure further relates to an electronic power converter, such as an amplifier, implementing such method.

### BACKGROUND

Electronic power converters, e.g. switched-mode power converters, such as amplifiers nowadays typically comprise switches, such as controlled and uncontrolled switches, for controlling the flow of currents. Examples of such uncontrolled and controlled switches are diodes and transistors (e.g. IGBT's and MOSFET's), respectively. All these switches degrade through usage, wherein the extent of degradation is closely related to the temperature and the amount of thermal cycles to which these switches are exposed. Knowing the remaining lifetime of switches incorporated in these devices can be advantageous for scheduling preventive maintenance leading to a reduction in down-time or the re-use of components for refurbishment of the equipment.

In fields wherein switching or switched-mode power converters have a relatively constant power usage and comprise components with slow thermal response time, the lifetime can be estimated based on relatively high-level and well-known lifetime models for instance regarding mechanical fatigue, electrical voltage stress and thermal stress (e.g. measured with a temperature sensor). However, in other fields (e.g. gradient amplifiers) wherein the power converters are exposed to relatively fast varying load profiles and corresponding changes in power dissipation such relatively high-level and well-known models cannot be used for modelling the remaining lifetime. In such devices the impact of the thermal cycling on the lifetime of the switches requires more accurate lifetime estimation models.

U.S. Pat. No. 10,481,207 B2 discloses a switching amplifier including a power device and a processing device. The power device is configured for powering a load and is comprised of a plurality of controlled switches. The processing device is configured to calculate a switch junction temperature for a bonding wire in each controlled switch based at least in part on a power loss of each controlled switch; generate a first accumulated fatigue damage of the bonding wire in each controlled switch based on the switch junction temperature; and generate an estimated remaining lifetime of the switching amplifier based on the first accumulated fatigue damages of the bonding wires in each controlled switch.

The disadvantage of the solution described in U.S. Pat. No. 10,481,207 B2 is that the processing load for generating the estimated remaining lifetime of the switching amplifier is very high since the switch junction temperature is determined in respect of each controlled switch of the switching amplifier. Furthermore, it does not provide a solution for refurbishment of electronic power converters by replacement of power modules.

### SUMMARY

It is an object of the present disclosure to solve at least one, preferably all of the disadvantages related to the prior art. Particularly, it is an object of the present disclosure to provide a method of determining an accumulated fatigue damage of a switching power converter that is simpler and reduces processing load while hardly affecting the accuracy of the accumulated fatigue damage estimation.

According to a first aspect of the present disclosure, there is provided a method, preferably a computer-implemented method, for estimating an accumulated fatigue damage of a switching power converter comprising a plurality of power modules each comprising a first semiconductor device, comprises: (i) determining of the plurality of power modules, a single power module having the first semiconductor device being thermally most heavily stressed; (ii) measuring during operation of the switching power converter a reference temperature related to a temperature of at least the single power module; (iii) determining a current of the switching power converter, particularly a current representative of a power dissipation through the first semiconductor device; and (iv) calculating a first single fatigue damage of the first semiconductor device of the single power module based at least on the current and the reference temperature. A first accumulated fatigue damage of the switching power converter can be determined based on the first single fatigue damage.

In a switching power converter comprising a plurality of power modules each comprising a first semiconductor device there is always one power module comprising a respective first semiconductor device that is thermally most heavily stressed. This first semiconductor device is considered rate determining for fatigue damage of the entire power module, and eventually the entire power converter. Such a semiconductor device advantageously refers to a switching device, particularly an uncontrolled switch. Typically, this one power module of the plurality of power modules does not change over time and thus by calculating an accumulated fatigue damage based on the single fatigue damage of the first semiconductor device that is rate determining for fatigue damage, a remaining lifetime of a switching power converter can be determined. By determining the single fatigue damage only in respect of the one power module having the first semiconductor device that is thermally most heavily stressed and not in respect of the other power modules of the plurality of power modules, computation effort is reduced. As a result, the method according to the present disclosure reduces the processing load required for determining the accumulated fatigue damage and the remaining lifetime.

Advantageously, the method further comprises a step of estimating a remaining lifetime based on the accumulated fatigue damage. Typically, a newly manufactured switching power converter has a known remaining lifetime. In light of this known remaining lifetime and calculated accumulated fatigue damage, a remaining lifetime can be determined in terms of for instance operating hours at an average load.

In a preferred embodiment, the method further comprises a step of storing at least one of the accumulated fatigue damage and the remaining lifetime. By storing such accumulated fatigue damage and/or remaining lifetime on the switching amplifier the switching amplifier may be re-used in a different amplifier system, e.g. in refurbishment operations. This is therefore particularly suitable for switching power converters comprising replaceable power modules.

The single fatigue damage of the first semiconductor device of the one power module is determined based on a reference temperature related to a temperature of the one power module and a current of the power converter. To this end, the method can further comprise the step of measuring during operation of the switching power converter a reference temperature in respect of each power module of the plurality of power modules of the switching power converter. A reference baseline (e.g. average) case temperature of the power module is advantageously determined utilizing the measured temperature. Determining the one power module comprising the semiconductor device that is thermally most heavily stressed (the critical power module) advantageously comprises measuring the reference temperature in respect of each power module of the plurality of power modules, and optionally selecting the power module of the plurality of power modules having the highest measured reference temperature as the critical power module. This is ideally suitable in situations wherein the power module comprising the thermally most heavily loaded semiconductor device is not known in advance (e.g. at the manufacturing stage) and/or changes over time. Although the accumulated fatigue damage determined by the method according to the present disclosure may in such case be different from the actual accumulated fatigue damage of the switching power converter, it will remain highly representative for the accumulated fatigue damage. Furthermore, it outweighs the disadvantage presented by the solutions known in the art.

Each reference temperature may be measured using a thermistor. Preferably, such thermistor is incorporated in the corresponding power module of the plurality of power modules. This provides an accurate measurement of a reference temperature that may be used for determining a case temperature. For instance, it may be provided at or near the baseplate of power modules. Alternatively, the reference temperature can be measured at any other suitable location which provides an indication of or relation with the temperature of the power module, e.g. a temperature of coolant fluid utilized to cooling the power module.

In an advantageous embodiment, calculating the single fatigue damage is based on a case temperature of the single power module. Preferably, the case temperature is determined based on at least one of the reference temperature of the single power module and the power dissipation of the single power module. For example, the case temperature is determined based on the reference temperature of the single power module and the power dissipation of the single power module, wherein both may form inputs of a case temperature model for determining the case temperature. The power dissipation of the single power module may be determined based on the current of the switching amplifier, which may be based on at least one of a measured current and a reference current of the switching amplifier.

Calculating the single fatigue damage for instance comprises calculating a junction temperature of the semiconductor device. Preferably, the junction temperature is calculated based on the case temperature of the single power module and the power dissipation of the first semiconductor device, wherein both may form inputs of a semiconductor thermal model for calculating the junction temperature.

Advantageously, the method according to the present disclosure further comprises the step of comparing the junction temperature to a pre-defined junction temperature. Preferably, such method further comprises a step of disabling the switching amplifier in the event that the junction temperature exceeds the pre-defined junction temperature. Such an overtemperature protection protects against acute damage to the first semiconductor device.

Additionally, or alternatively, calculating the single fatigue damage of the first semiconductor device can comprise determining a power dissipation of the first semiconductor device based on a current of the switching power converter, particularly a current of the respective power module incorporating the first semiconductor device. The current may be a predetermined current, such as a reference or set current, or may be measured during operation of the switching power converter. The current can refer to a current representative of a current through the first semiconductor device. Using the current, the single fatigue damage may for instance be determined by means of a thermal model of the first semiconductor device.

Advantageously, the single power module comprises a second semiconductor device, the first semiconductor device and the second semiconductor device conducting currents of opposite sign. The method can further comprise calculating a second single fatigue damage of the second semiconductor device based at least on the current and calculating a second accumulated fatigue damage of the switching power converter based on the second single fatigue damage. Advantageously, the second single fatigue damage is determined only in respect of the single power module and not in respect of the other power modules of the plurality of power modules.

The single power module advantageously comprises a third semiconductor device, wherein the first and the third semiconductor device form a first switching pair and wherein one of the first and the third semiconductor device comprises or consists of a controlled switch and the other one of the first and the third semiconductor device comprises or consists of an uncontrolled switch. The first and the third semiconductor device are preferably connected in series and hence are configured to conduct current of a same sign (e.g. positive or negative). Such a first switching pair, wherein the controlled and uncontrolled switch may be placed in series has the benefit of providing a freewheeling path to the current, reducing a spike at a load. Preferably, the first semiconductor device comprises or consists of the uncontrolled switch, e.g. a diode. In such configuration, the semiconductor device that is typically thermally most heavily stressed, such as the first semiconductor device, of the switching power converter is used for determining the single fatigue damage. It will be convenient to note that the uncontrolled switch as utilized herein advantageously does not refer to the internal body diode of a controlled semiconductor device, rather to an external (additional) uncontrolled semiconductor switch.

In an advantageous embodiment, the single power module comprises a second switching pair comprising the second and a fourth semiconductor device, wherein the second and the fourth semiconductor devices are preferably connected in series. One of the second and the fourth semiconductor device comprises or consists of a controlled switch and the other one comprises or consists of an uncontrolled switch. The first and the second switching pair are configured for conducting corresponding currents of opposite sign. In such an embodiment, a further single fatigue damage may be determined for the second semiconductor device of the second switching pair. Furthermore, calculating the accumulated fatigue damage of the switching power converter may be based on the further single fatigue damage. The further single fatigue damage is advantageously determined only in respect of the single power module and not for the other power modules of the plurality of power modules. Preferably, the second semiconductor device of the second switching pair and the first semiconductor device of the first switching pair are of a same, advantageously identical, device type. For instance, each of the first and the second semiconductor devices comprises or consists of the uncontrolled switch. In such configuration comprising a first and a second switching pair, the thermally most heavily stressed semiconductors, such as the first semiconductor devices, of the switching power converter are incorporated in the same power module and both can be used for calculating the single fatigue damage.

According to a second aspect of the present disclosure there is provided an electronic power converter, particularly a switching power converter comprising a processing unit configured to implement the method according to the first aspect.

According to a third aspect of the present disclosure, there is provided an amplifier system comprising at least one electronic power converter according to the second aspect.

According to a fourth aspect of the present disclosure, there is provided an MRI system comprising at least one electronic power converter according to the second aspect, or at least one amplifier system according to the third aspect. Advantageously, the MRI system comprises a gradient amplifier system and a plurality of field coils aligned according to three orthogonal axes. The gradient amplifier system comprises an amplifier system according to the third aspect configured to generate a current in the field coil in respect of at least one of the three orthogonal axes and preferably three amplifier systems according to the first aspect each configured to generate a current in the field coil in respect of one of the three orthogonal axes.

According to a further aspect of the present disclosure, a method for protecting a switching power converter against excess temperature is provided. The switching power converter comprises a plurality of power modules each comprising a first semiconductor device as described herein. The method according to the present aspect comprises: (i) determining of the plurality of power modules, a single power module having the first semiconductor device being thermally most heavily stressed; (ii) determining a current of the switching power converter, particularly a current representative of a power dissipation through the first semiconductor device; (iii) calculating a junction temperature of the first semiconductor device; and (iv) comparing the junction temperature to a pre-defined junction temperature threshold, preferably further comprising disabling the switching power converter in the event that the junction temperature exceeds the pre-defined junction temperature threshold. The junction temperature can be calculated as described in the present disclosure. Preferably, calculating the junction temperature comprises determining a power dissipation of the respective semiconductor device based on the current of the switching power converter, and optionally based on a duty cycle (D) of the single power module. In addition, or alternatively, calculating the junction temperature comprises determining a case temperature of the single power module, preferably wherein determining the case temperature comprises at least one of measuring a reference temperature associated with the single power module and determining a power dissipation of the single power module, preferably wherein the power dissipation of the single power module is determined based on the current of the switching power converter, preferably the current being determined by at least one of a measured current and a reference current of the switching power converter. Advantageously, the single power module comprises a second semiconductor device, the first semiconductor device and the second semiconductor device carrying currents of opposite sign, the method further comprising calculating a second junction temperature of the second semiconductor device substantially in a same way as for the first semiconductor device and comparing the second junction temperature to the pre-defined junction temperature threshold.

### BRIEF DESCRIPTION OF THE DRAWINGS

Aspects of the present disclosure will now be described in more detail with reference to the appended drawings, wherein same reference numerals illustrate same features and wherein:

FIG. 1 represents a diagram with the main components of a power amplifier axis.

FIG. 2 represents a switching cell and depicts how multiple power modules with IGBTs, Diodes and NTCs are connected in the switching cell.

FIG. 3 represents a diagram of a power module arrangement.

FIG. 4 represents a cross section along section line I-I of the power module arrangement of FIG. 3 showing the stack-up of a diode-switch combination.

FIG. 5 represents a diagram of a method for lifetime estimation and optionally over temperature protection in accordance with aspects of the present disclosure.

FIG. 6 represents a diagram for determining a diode junction temperature according to an aspect of the present disclosure.

FIG. 7 represents a diagram of control logic for determining a lifetime of an amplifier according to aspects of the present disclosure.

FIG. 8 represents an electric equivalent circuit simulating a thermal model of a diode which can be implemented in the diagram of FIG. 6 to determine a diode junction temperature.

FIG. 9 represents an electric equivalent circuit simulating a thermal model of a power module which can be implemented in the diagram of FIG. 6 to determine a case surface temperature.

FIG. 10 represents a diagram of an MRI system comprising a gradient amplifier according to aspects of the present disclosure.

### DETAILED DESCRIPTION

Exemplary embodiments of the present disclosure will be described with reference to a switching amplifier, as illustrated in the accompanying drawings. It will however be convenient to note that aspects of the present disclosure are applicable to any other electronic, e.g. switching, power converter.

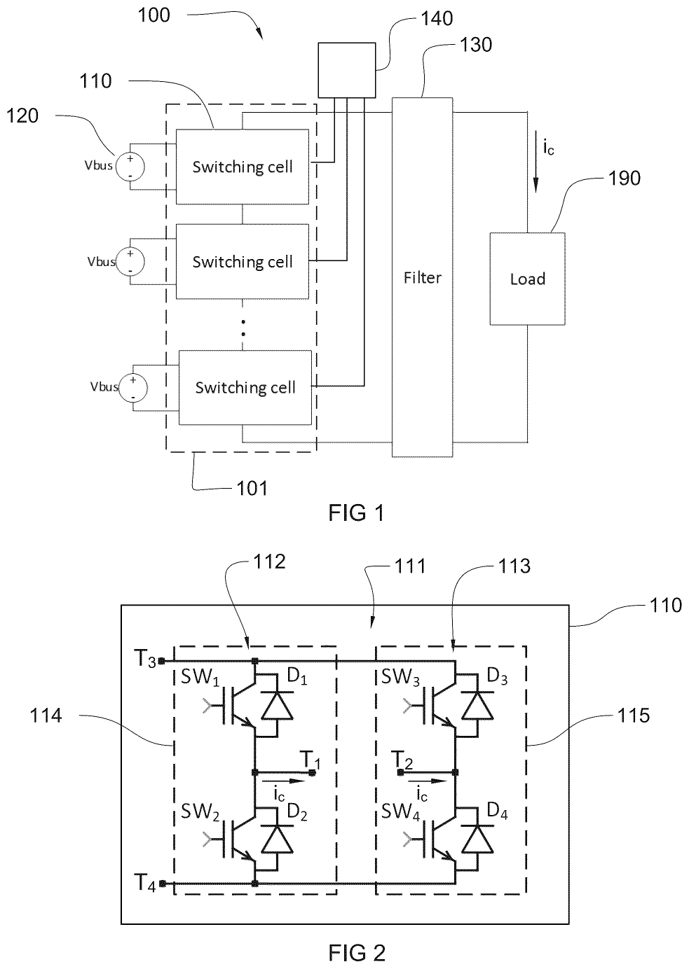

Referring to FIG. 1, a switching amplifier 100 comprises a stack 101 of switching cells 110 that jointly provide an output power of the amplifier. The switching cells 110 can be arranged in series in stack 101 to provide an output voltage being the sum of the individual output voltages, or they can be arranged in parallel in the stack to provide an output current being the sum of the individual output currents. A combination of a series arrangement and a parallel arrangement of switching cells 110 is possible. A power source 120 can be associated with each switching cell 110. Power source 120 is advantageously a DC voltage supply. The output of the stack 101 is provided to a load 190. A filter 130, such as a low-pass filter, can be provided at the output of the stack 101, to filter the output provided to load 190. A control unit 140 controls operation of the switching cells 110. Particularly, control unit 140 is configured to operate controllable switches in the switching cells.

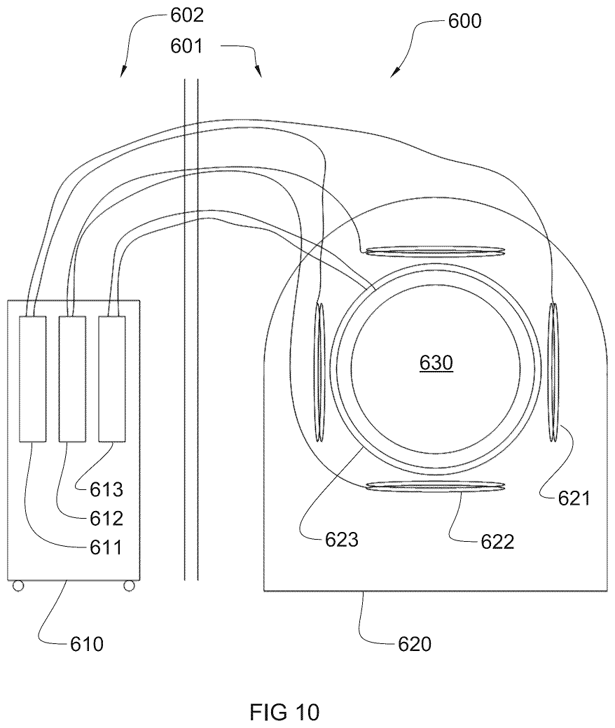

Switching amplifier 100 can represent a power amplifier axis of a gradient amplifier of a magnetic resonance imaging (MRI) system. Referring to FIG. 10, MRI system 600 comprises a patient scan device 620 coupled to a gradient amplifier system 610, both being typically arranged in separate rooms 601, 602 respectively. Patient scan device 620 comprises a plurality of field coils 621, 622, 623 aligned according to three orthogonal axes and surrounding a patient scan area 630. Field coils 621, 622, 623 are arranged to generate a magnetic field in patient scan area 630. Gradient amplifier system 610 typically comprises three advantageously identical power amplifier axes 611, 612, 613, each of which may correspond to amplifier 100 of FIG. 1, and each power amplifier axis is configured to generate a current for a field coil 621, 622, 623 respectively, according a different one of three orthogonal axes. Each of the power amplifier axes 611, 612, 613, or parts thereof, such as the stack 101 or the switching cells 110 of amplifier 100, are advantageously field replaceable.

Referring to FIG. 2, a switching cell 110, such as the ones utilized in amplifier 100, can comprise one or a plurality of bridge circuits 111. Each bridge circuit 111 can be a full bridge circuit consisting of two bridge legs 112 and 113 as known in the art. The bridge circuit 111 can be connected to the power source 120 and yields an output voltage between output terminals T₁ and T₂. Other bridge circuit configurations can alternatively be utilized. By way of example, the bridge circuit can be a half bridge circuit, consisting of a single bridge leg (not shown).

Each of the one or more bridge legs 112, 113 comprises two controllable switches, SW₁ and SW₂ of bridge leg 112 and SW₃ and SW₄ of bridge leg 113, connected in series between the input terminals T₃ and T₄ of the bridge circuit 111. Output terminals T₁ and T₂ are connected to the connection points (midpoints) between the two switches SW₁ and SW₂, and SW₃ and SW₄ respectively. The input terminals T₃, T₄ are connected to the positive and negative poles of the power source 120, respectively. The controllable switches SW₁, SW₂, SW₃ and SW₄ can be IGBTs (Insulated Gate Bipolar Transistor), MOSFETs (Metal Oxide Semiconductor Field Effect Transistor), BJT (Bipolar Junction Transistor) or any other suitable controllable semiconductor device.

Each controllable switch SW₁, SW₂, SW₃ and SW₄ in bridge legs 112, 113 can be coupled in (anti) parallel with a diode D₁, D₂, D₃ and D₄ respectively. When considering the current i_{c} at terminals T₁, T₂ to have positive sign when flowing in direction of the arrow in FIG. 2, a positive current i_{c} will result in heating of switches SW₁ and SW₄ (when conducting) and heating of diodes D₂ and D₃ when SW₁ and SW₄ are not conducting. When i_{c} is negative, this will result in heating of switches SW₂ and SW₃ (when conducting) and heating of the diodes D₁ and D₄ when SW₂ and SW₃ are not conducting. In bridge leg 112 hence two switch pairs can be defined as consisting of a controlled switch and a diode arranged in series which are subject to heating due to current of a same sign, i.e. SW₁ and D₂ form a first switch pair and SW₂ and D₁ form a second switch pair. For bridge leg 113, the switch pairs can be defined as SW₃, D₄ and SW₄, D₃. Each of the switch pairs is connected between the positive input terminal T₃ and the negative input terminal T₄. The operation of the controllable switches SW₁, SW₂, SW₃ and SW₄ is controlled via control unit 140, e.g. based on pulse width modulation as known in the art. Typically, the controlled switches of each bridge leg, e.g. SW₁ and SW₂ of bridge leg 112, are operated with complementary duty cycles. In bridge leg 112, the duty cycle D of SW₁ is complementary to the duty cycle (1-D) of SW₂. This means that either SW₁ is enabled or SW₂. In bridge leg 113, SW₃ switches with a duty cycle 1-D and SW₄ with duty cycle D.

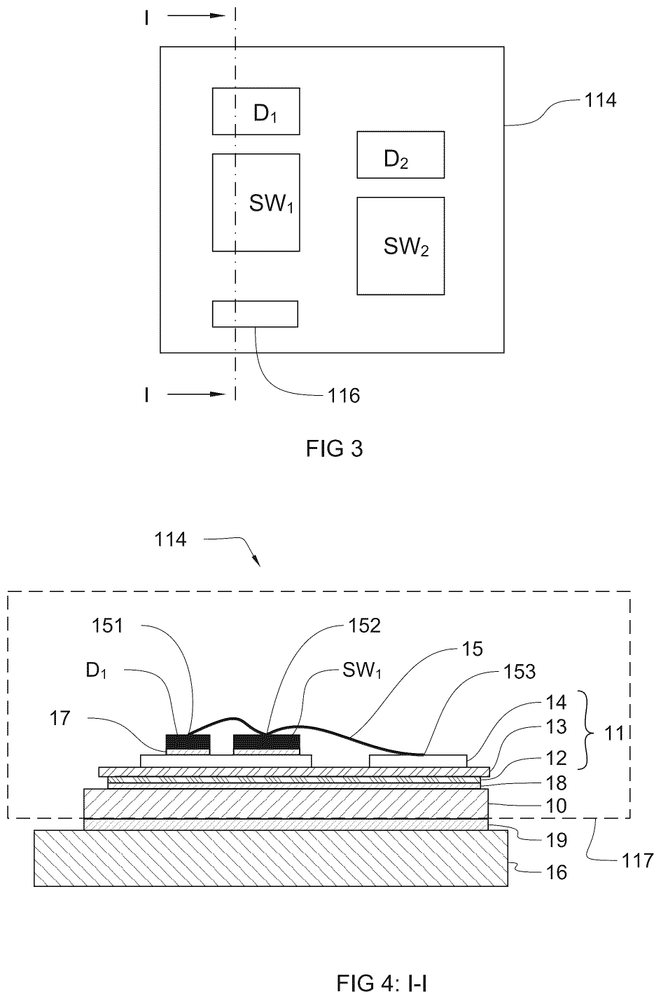

Referring to FIG. 3, in a practical realization, the switch pairs are arranged in power modules 114. Each power module can comprise one or a plurality of switch pairs, for example the two switch pairs SW₁, D₁ and SW₂, D₂ of a bridge leg 112. In the illustrated example of FIG. 2, two power modules 114, 115 realize the bridge legs 112 and 113 respectively.

Still referring to FIG. 3, each power module 114 advantageously comprises a single baseplate on which all the switch pairs SW₁, D₂ and SW₂, D₁ of the power module 114 are arranged. In a practical realization, each switch pair may be provided as one or a plurality of switch pairs (e.g. arranged in parallel) jointly operating as one switch pair. The power module 114 advantageously comprises a temperature sensor 116 configured to measure a surface temperature of the baseplate. A suitable example of temperature sensor 116 is a thermistor, particularly a NTC (Negative Temperature Coefficient) temperature sensor. Temperature sensor 116 can be coupled to control unit 140 to detect an output of the sensor 116.

A structure of a power module arrangement is illustrated in FIG. 4. All the semiconductor switches (both diodes and controllable switches) of the power module are arranged on a same base plate 10. The base plate 10 hence defines the power module 114. A stack-up comprising the semiconductor switches is provided on the base plate 10. The semiconductor switches, e.g. diode D₁ and controllable switch SW₁, are provided on a substrate 11 and coupled to it through a chip solder layer 17. The substrate 11 can comprise one or a plurality of layers 12, 13, 14 stacked onto one another. Substrate 11 is arranged on base plate 10 and coupled to it through a base plate solder layer 18. The substrate layers 12-14 can be made of a same or different materials, such as direct bonded copper substrate materials, e.g. comprising one or more sheets of copper or aluminium, possibly on a ceramic insulating material such as alumina (Al₂O₃), aluminium nitride (AlN), or beryllium oxide (BeO). The base plate can be made of a same or a different material compared to the substrate, such as aluminium nitride ceramic, copper or aluminium. A bondwire 15 electrically connects one or more of the diode D₁, the switch SW₁ and the substrate 11 at bonds 151, 152 and 153 respectively. The power module 114 is advantageously contained within a single case 117, in which the entire stack-up can be potted. The base plate 10 (and hence case 117) can be arranged on a heatsink 16 and thermally coupled to it through a thermally conductive coupling material 19, such as thermal grease.

The temperature sensor 116 (FIG. 3) can be configured to measure a temperature of the base plate 10. Alternatively, it can be configured to measure a temperature of the substrate 11, the case 117, one of the solder layers 17, 18, coupling layer 19, or elsewhere, e.g. a temperature of coolant water utilized as coolant for the power module 114.

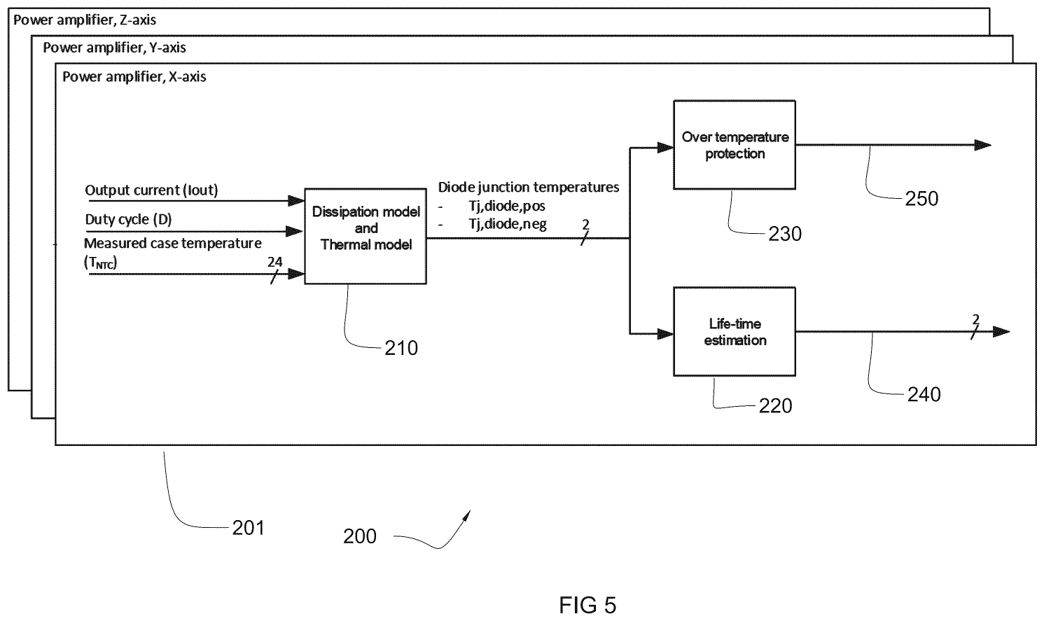

Referring to FIG. 5, a control device 200 for estimating an accumulated fatigue damage or a remaining lifetime of a switching amplifier, such as a gradient amplifier, can comprise an individual control block 201 for each axis power amplifier, e.g. for the X, Y and Z axes (e.g. axis power amplifiers 611, 612, 613 of system 610 of FIG. 10). Control block 201 can be comprised in control unit 140 of switching amplifier 100 and can be provided as a hardware implementation, a software implementation, or a combination of both. As described above, each axis power amplifier comprises a plurality of switching cells 110 (FIG. 1) and each switching cell comprises one or a plurality of bridge circuits, e.g. full or half bridge circuits. Each bridge circuit can comprise one or more power modules as described above.

Each control block 201 is configured to determine an accumulated fatigue damage and/or a remaining lifetime of the respective axis power amplifier and receives as input an output current Iₒᵤₜ of the axis amplifier and possibly a measured temperature T_{NTC} of one or more, preferably all, of the power modules of the respective amplifier, e.g. as measured by temperature sensor 116. The output current Iₒᵤₜ can refer to a reference (set) current, a measured current, or a combination of both. The measured temperature T_{NTC} can refer to any suitable temperature indicative of a temperature of the power module. Control block 201 can be configured to determine the power module having the highest measured temperature T_{NTC}. Control block 201 can receive a duty cycle D of the controllable switches of one or more of the power modules of the respective amplifier as input. To determine the accumulated fatigue damage, control block 201 is advantageously configured to determine a (single) fatigue damage of one or more semiconductor switches, preferably one or more diodes (uncontrolled switches) comprised in one power module of the plurality of power modules of the amplifier, although determining the fatigue damage of one or more semiconductor switches in more power modules of the amplifier can be contemplated. Advantageously, control block 201 is configured to determine the (single) fatigue damage of a first switch, preferably first diode, configured to conduct positive current (e.g. i_{c}) and/or of a second switch, preferably second diode, configured to conduct negative current (e.g. −i_{c}) of a single one power module of the amplifier. The first and second switches (diodes) are hence advantageously comprised in a same power module. It can alternatively be contemplated to determine the fatigue damage of a first and a second switch in a plurality of power modules. As indicated previously, the positive and negative currents will thermally affect different switch pairs. Possibly, positive and negative current affects the respective switch pairs to a different extent, and it can be beneficial to determine the fatigue damage in relation to both the positive current and the negative current separately. It is advantageous to determine the fatigue damage of the uncontrolled switches (diodes) rather than the controlled switches, since the former ones are generally more affected by temperature and thermal stress.

Advantageously, control block 201 is configured to determine (estimate) a switch junction temperature, preferably a diode junction temperature of the one or more switches (diodes), such as the first switch (diode) and the second switch (diode). The control block 201 can be configured to determine the fatigue damage of the one or more switches (diodes) based on the determined switch (diode) junction temperature of the corresponding switch (diode). To this end, control block 201 advantageously comprises logic block 210 and logic block 220. In the following the operation of control block 201 is described taking as example determination of the diode junction temperature. It will however be appreciated that a junction temperature of a controllable switch can be utilized in the alternative.

In some examples, logic block 210 is configured to determine at least one diode junction temperature based on the output current Iₒᵤₜ, at least one measured temperature T_{NTC} and optionally the duty cycle D (of the corresponding power module) received as input to logic block 210. The diode junction temperature can be determined on the basis of a heat dissipation model of the corresponding diode or power module as will be described further below. The diode junction temperature determined by logic block 210 is applied to logic block 220 for determining a (single) fatigue damage of the corresponding diode. Advantageously, logic block 210 is configured to determine a diode junction temperature for either one or both of the first diode (T_{j,diode,pos}) and the second diode (T_{j,diode,neg}) of just one power module of the plurality of power modules, although determining the diode junction temperatures in more than one power module can be contemplated. Logic block 220 is advantageously configured to determine a fatigue damage 240 of each diode for which it receives a diode junction temperature from logic block 210. Advantageously, logic block 220 is configured to determine a number of thermal cycles based on the diode junction temperature, representative of an accrued (single) fatigue damage. Logic block 220 can determine an accumulated fatigue damage and/or a remaining lifetime based on the accrued fatigue damage.

Optionally, control block 201 can be configured to determine a condition representative of an excess temperature in at least one power module. Logic block 230 advantageously receives at least one diode junction temperature from logic block 210. Logic block 230 is configured to determine a condition representative of an excess temperature based on the at least one diode junction temperature. Such a condition can be determined for at least one power module. Logic block 230 is advantageously configured to output an error or alarm signal 250 when the condition representative of an excess temperature is met.

To reduce computing effort, control block 201 is configured to determine the power module, amongst the plurality of power modules of the axis power amplifier, having a switch or switch pair, advantageously a diode, being thermally most heavily stressed. In some examples, a temperature T_{NTC} representative of a case temperature is measured in respect of each power module of the power amplifier, e.g. with temperature sensor 116 (FIG. 3). The power module having a highest measured temperature is identified, e.g. in logic block 210. This power module is selected as the power module having a switch or switch pair being most heavily stressed, referred to in the following as the critical power module. In other examples, the critical power module is determined or identified in advance, e.g. by analysing a position of each of the plurality of power modules and selecting the power module which corresponds with a position of highest thermal load as the critical power module. Particularly, when the plurality of power modules are disposed in an array, typically the first or the last power module of the array will be subjected to the highest thermal load and will comprise the switch or switch pair being thermally most heavily stressed. In such case, this first or last power module can be selected to be the critical power module. In some examples, the power modules is cooled by a cooling fluid, specifically a cooling liquid, that flows serially along the power modules. In such case, the power module that is disposed last along the cooling fluid circuit typically will have a highest temperature and can be selected as the critical power module. In these cases, it is generally not required to measure a case temperature in respect of each of the plurality of power modules. The logic described herein for determining a diode junction temperature and a diode fatigue damage is advantageously performed only for the critical power module, rather than for all power modules.

Advantageously, a first diode being thermally most heavily stressed (critical first diode) is determined among the switch pairs of the critical power module conducting positive current and a second diode being most heavily stressed (critical second diode) is determined among the switch pairs of the critical power module conducting negative current. A diode junction temperature and a diode fatigue life is advantageously determined only for the critical first and/or second diode, as the diode being thermally most heavily stressed typically will be the first diode to fail. Any suitable thermal model can be applied to determine the critical diode (i.e. being thermally most heavily stressed). By way of example, the diode being thermally most heavily stressed can be determined based on a temperature measurement (T_{NTC}) and/or analysing the position of the diode in the power module or by design. In some examples, the diode being thermally most heavily stressed can be determined by simulation of thermal stress and/or simulation of electric current distribution between the diodes or semiconductor devices of the (critical) power module. Alternatively, all the switch pairs of the critical power module, e.g. the ones switching positive current and/or the ones switching negative current respectively, can be regarded as equal, e.g. because they would conduct equal currents. In the latter case, all diodes of the critical power module are considered as critical and it will suffice when logic block 210 determines a junction temperature of only one such first diode and/or only one such second diode.

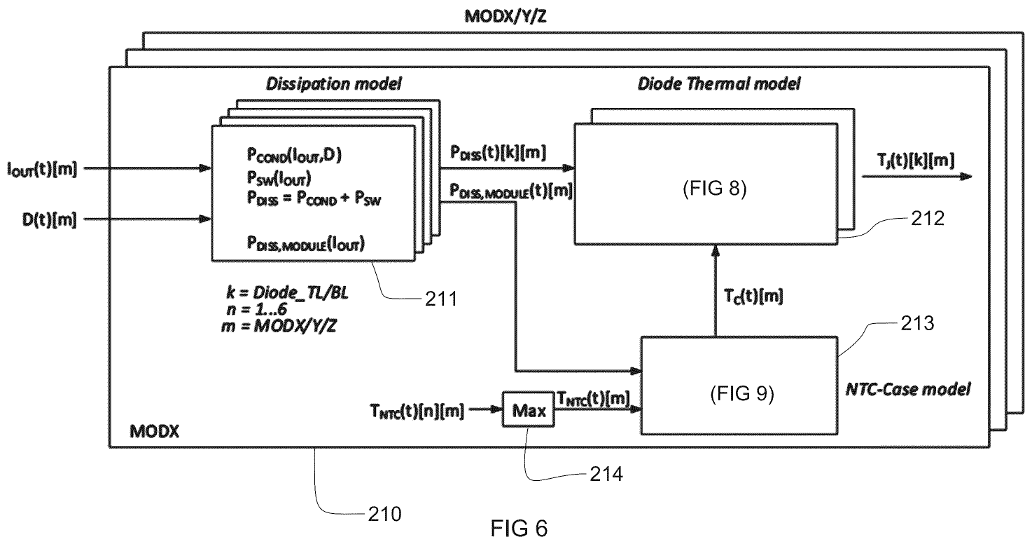

Referring to FIG. 6, to determine at least one diode junction temperature, logic block 210 advantageously implements one or more of: a dissipation model 211 of a power module, a thermal model 212 of a diode and a thermal model 213 of the power module. Firstly, logic block 210 can determine the power module being thermally most heavily stressed (critical power module), e.g. by identifying the power module having the highest measured temperature T_{NTC}, and execute operations of sub-blocks 211, 212 and 213 only in respect of the critical power module. This identification can be performed in logic operator 214 as described below.

Dissipation model 211 takes as input the output current Iₒᵤₜ(t) and possibly the duty cycle D (t) of the respective power module (e.g. the critical power module). Both the output current and duty cycle may be time varying during operation of the amplifier. Based thereon, dissipation model 211 is configured to determine a power dissipation P_{DISS,MODULE}(t) of the respective power module and/or a power dissipation P_{DISS}(t)[k] of at least one switch [k] of the respective power module, advantageously of the switch (diode) being thermally most heavily stressed (critical switch/diode). Advantageously, P_{DISS}(t)[k] is determined for two switches [k] being a first critical switch (diode) conducting positive current and a second critical switch (diode) conducting negative current. Both P_{DISS,MODULE}(t) and P_{DISS}(t)[k] may be time varying and therefore computed over consecutive periods of time (t). These periods of time (t) can be constant, e.g. time intervals of fixed length, or varying, e.g. defined by periods over which the output current Iₒᵤₜ is constant. Possibly, the dissipation model 211 only takes the output current and the duty cycle into account for determining P_{DISS,MODULE}(t) and P_{DISS}(t)[k] and advantageously does not utilize a temperature measurement, such as measurement of temperature sensor 116 (FIG. 3). By way of example, P_{DISS}(t)[k] is determined based on a first term P_{COND} representative of conduction losses through the corresponding switch [k] (diode) and a second term P_{SW} representative of switching losses of the corresponding switch [k] (diode):

$${P}_{DISS} ( t ) [ k ] = {P}_{COND} [ k ] + {P}_{SW} [ k ] .$$

The first term P_{COND} can be determined based on Iₒᵤₜ and the duty cycle D of the respective power module. Particularly, an instantaneous power dissipation is determined by multiplying the current (Iₒᵤₜ) with the voltage drop across the switch or switch pair. The average power dissipation (P_{COND}) can be determined by averaging the instantaneous power dissipation over a switching period utilizing the duty cycle (D) of the power module. The second term P_{SW} is advantageously determined by determining the switching energy losses based on Iₒᵤₜ and multiplying the switching energy losses with the switching frequency of the switches. Advantageously, the duty cycle D is not taken into account for determining P_{SW}. Advantageously, P_{DISS}(t) is determined for both the first critical switch (diode) and the second critical switch (diode) as defined above.

Thermal model 212 implements a thermal model for a switch, particularly a diode, and receives as possible first input, the power dissipation P_{DISS}(t)[k] of the corresponding switch (diode) output from dissipation model 211. A reference temperature T_{C}(t) of the respective power module (case temperature) can be supplied as a possible second input. Thermal model 212 advantageously implements a thermal model for each switch [k] for which dissipation model 211 outputs a power dissipation P_{DISS}(t)[k], e.g. for the first critical diode and the second critical diode. Thermal model 212 is configured to determine a junction temperature Tⱼ(t)[k], for each of the one or more switches (diodes)[k], advantageously based on a power dissipation P_{DISS}(t)[k] of the corresponding switch and on the reference temperature T_{C}(t) of the respective power module.

Any suitable thermal model of a switch, particularly a diode, can be used to determine the junction temperature of the switch (diode). One possible thermal model 400 is illustrated in FIG. 8 as an electrical equivalent RC circuit and can comprise a series arrangement 410 of a plurality of circuits 411, each circuit 411 comprising a resistor R and a capacitor C in parallel. Series arrangement 410 can be connected at one end to a current source representing P_{DISS}(t) and to a voltage source 430 representing a case (reference) temperature T_{C}(t) at the other end. The junction temperature Tⱼ(t) can be determined on the basis of the equivalent electric current in node 440 connecting the current source 420 to the series arrangement 410. Thermal model 400 is particularly suitable for modelling the thermal behaviour of a diode.

Referring again to FIG. 6, logic block 210 can comprise a second thermal model 213 configured to determine a case temperature T_{C}(t) representative of a temperature of the case 117, the base plate 10 or a substrate 11 of the power module 114 (FIG. 4). Logic block 210 can receive temperature measurements T_{NTC} (t) for all power modules of the amplifier, and a logic operator 214 can be configured to identify the power module having the maximum measured temperature T_{NTC} (t), i.e. the critical power module. Thermal model 213 is advantageously configured to determine case temperature T_{C}(t) only for the critical power module as identified by logic operator 214.

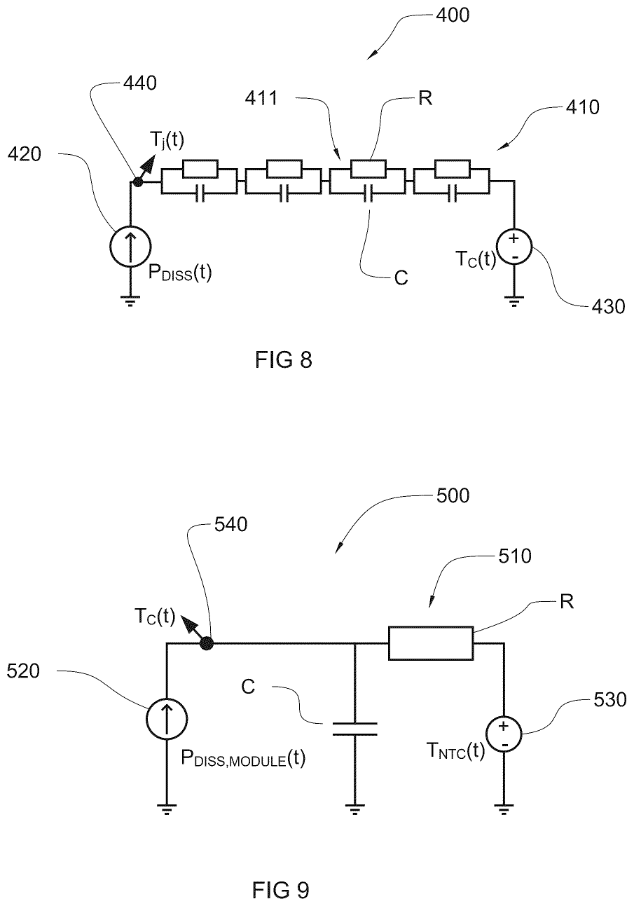

Thermal model 213 receives as input a measured temperature T_{NTC} (t) measured by temperature sensor 116 of the critical power module, e.g. as identified by logic operator 214, and P_{DISS,MODULE}(t) determined by dissipation model 211 in respect of the same power module. Thermal model 213 is configured to determine case temperature T_{C}(t) based on the measured temperature T_{NTC} (t) and power dissipation P_{DISS,MODULE}(t) of the respective power module. Any suitable thermal model for modelling a thermal behaviour of a power module, e.g. taking account of the semiconductor components, stack-up and cooling system, may be used as the thermal model 213. One possible thermal model 500 is illustrated in FIG. 9 as an electric equivalent RC circuit 510 connected between a current source 520 representing P_{DISS,MODULE}(t) and a voltage source 530 representing T_{NTC} (t). The case temperature T_{C}(t) can be determined on the basis of the equivalent electric current in node 550 connecting the current source 520 to the RC circuit 510.

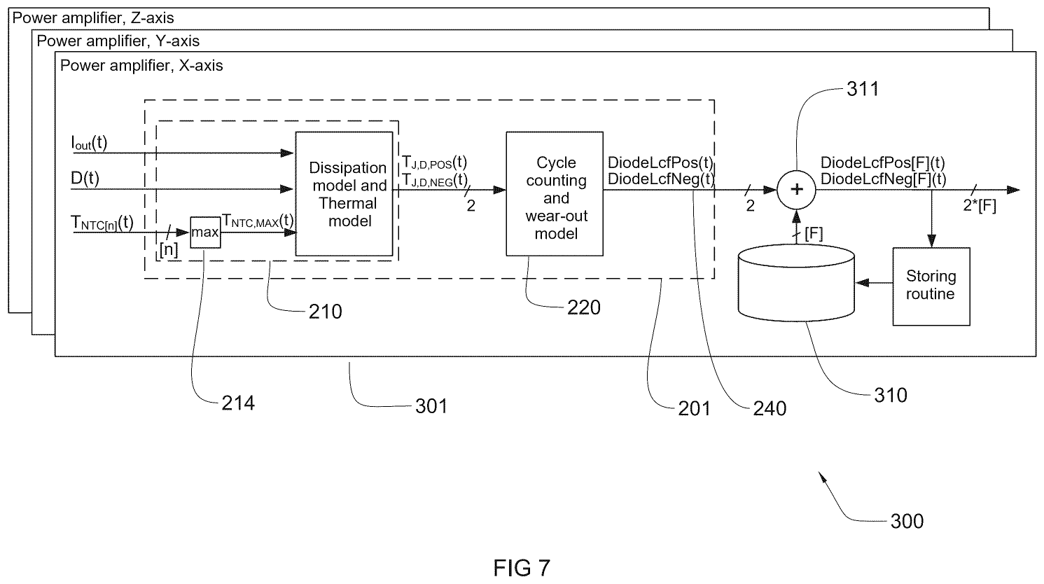

Referring to FIG. 7, a processing device 300 is configured to determine a lifetime estimation of an amplifier, such as a gradient amplifier. Processing device can comprise a processing block 301 for each axis power amplifier of the gradient power amplifier. Processing block 301 comprises control block 201 as described in the present disclosure. In particular, logic block 220 is configured to count a number of thermal cycles based on the junction temperature Tⱼ(t) determined in logic block 210. In some examples, logic block 220 is configured to count a first number of thermal cycles based on the junction temperature determined for the first critical switch (diode) and a second number of thermal cycles based on the junction temperature determined for the second critical switch (diode). A cycle counting algorithm, such as a rainflow-counting algorithm can be utilized for determining the number of thermal cycles.

Further, logic block 220 is configured to implement a wear-out model of the (critical) power module, configured to determine a life consumption of a switch associated with one or a number of thermal cycles determined by the cycle counting algorithm. The wear-out model can be provided by the power module manufacturer or based on design. The wear-out model is configured to determine a single fatigue damage associated with each thermal cycle or for a number of consecutive thermal cycles. The single fatigue damage is advantageously determined for each switch for which logic block 210 provides a junction temperature output, such as for the first critical diode and for the second critical diode separately and provided as an output of logic block 220.

Consecutively calculated single fatigue damages (as output by logic block 220) are added to one another in logic operator 311 and stored as an accumulated fatigue damage in a memory module 310, which preferably is a local memory of the switching power amplifier. The accumulated fatigue damage is advantageously stored for the first critical diode and the second critical diode individually. The memory module 310 can be configured to store the one or more accumulated fatigue damages determined in respect of each field replaceable unit F. The accumulated fatigue damage provides a measure of the actual life consumption of the switching device. The lifetime of a switching device in terms of total accumulated fatigue damage before failure is typically specified by the manufacturer of the switching device. The remaining lifetime corresponds to the specified total lifetime of the switching device corrected for by the accumulated fatigue damage:

remaining lifetime=total specified life time−accumulated fatigue damage.

Advantageously, a first remaining lifetime is determined for the first critical diode and a second remaining lifetime is determined for the second critical diode. The lowest one (i.e., worst-case) of the first and second remaining lifetime is selected as the remaining lifetime of the axis power amplifier. It will be appreciated that the accumulated fatigue damage can be stored in memory module 310 instead or in addition to storing the remaining lifetime, for either one or both the first critical switch (diode) and the second critical switch (diode).

Referring again to FIG. 5, to determine an excess temperature condition, logic block 230 can be configured to compare the junction temperature received from logic block 210 with a pre-defined threshold value. Particularly, both the junction temperature for the first critical diode and the junction temperature for the second critical diode are compared to respective predefined threshold values, which can be same or different. Error signal 250 can be emitted when the junction temperature, e.g. of at least one of the first and the second critical diodes, exceeds the threshold value. Control unit 140 (FIG. 1) can be configured to process error signal 250 to e.g. disable an amplifier output current and/or emit an alarm signal.

In some embodiments of the present disclosure, a method for determining a remaining lifetime estimation of an electronic power converter, such as an amplifier, comprises determining a first diode junction temperature estimation (T_{j,1}) of a first critical diode forming a point of failure of a first set of switching pairs and determining a second diode junction temperature estimation (T_{j,2}) of a second critical diode forming a point of failure of a second set of switching pairs. The first, respectively second critical diode can be selected amongst the diodes of the first/second set of switching pairs by design, or can be a representative one of the diodes of the first/second set of switching pairs.

The first set of switching pairs is configured for conducting a positive current and the second set of switching pairs is configured for conducting a negative current. The first set and the second set of switching pairs are advantageously arranged in a same power module, e.g. sharing a same baseplate, or potted in a same case. The electronic power converter can comprise a plurality of power modules. Advantageously, each one of the first set and the second set comprises one or more, e.g. three, switching pairs, which can be arranged in parallel. Each of the switching pairs comprises a single controllable switch and a single diode connected in series with the single controllable switch (i.e. conducting a current of a same sign). One of the switching pairs typically comprises the critical diode (single diode forming a point of failure).

Advantageously, the diode junction temperature estimation is determined by:
determining a case temperature (T_{C}) of a power module having a highest case temperature based on:
   measuring a temperature (T_{NTC}) representative of a case (surface) temperature of each power module, e.g. using a temperature sensor,
   identifying a critical power module, being the power module having a highest measured temperature,
   determining a power dissipation of the critical power module (P_{DISS,MODULE}) based on at least one of a current (I_{OUT}) of the power module and a duty cycle (D) of the power module,
   determining the case temperature (T_{C}) based on the measured temperature (T_{NTC}) and the power dissipation (P_{DISS,MODULE}) of the critical power module, and
determining the first and the second diode junction temperature estimation (T_{j,1}; T_{j,2}) based on a thermal model (power dissipation model) of the corresponding critical diode and the case temperature (T_{C}).

Advantageously, the power dissipation of the critical power module (P_{DISS,MODULE}) is determined by:
determining a power dissipation of each controlled switch of the critical power module and/or
determining a power dissipation of each uncontrolled switch (diode) of the critical power module.

In some embodiments of the present disclosure, the method for determining an accumulated fatigue damage estimation and/or a remaining lifetime estimation comprises:
counting a first number of thermal cycles based on the first diode junction temperature estimation,
counting a second number of thermal cycles based on the second diode junction temperature estimation,
determining a first accumulated fatigue damage and/or a first remaining lifetime based on the first number of thermal cycles,
determining a second accumulated fatigue damage and/or a second remaining lifetime based on the second number of thermal cycles,
determining the accumulated fatigue damage estimation and/or the remaining lifetime estimation based on a worst-case one of the first and second accumulated fatigue damage or remaining lifetime, respectively.

Advantageously, a power amplifier comprises a processing unit and a plurality of, e.g. six, full bridges, wherein each full bridge comprises a plurality of, e.g. four, power modules. The processing unit is advantageously configured to carry out a method for determining an accumulated fatigue damage estimation and/or a remaining lifetime estimation as described herein. The accumulated fatigue damage estimation and/or remaining lifetime estimation determined by the processing unit can be stored in a memory module of the processing unit.

Aspects of the present disclosure are set out in the following alphanumerically numbered clauses.
A1. Method for estimating an accumulated fatigue damage of a switching power converter (100) comprising a plurality of power modules (114, 115) each comprising a first semiconductor device (SW₁, D₁, SW₂, D₂), the method comprising:
   determining of the plurality of power modules, a single power module having the first semiconductor device being thermally most heavily stressed,
   measuring during operation of the switching power converter a reference temperature (T_{NTC}) related to a temperature of at least the single power module,
   determining a current (Iₒᵤₜ) of the switching power converter,
   calculating a first single fatigue damage of the first semiconductor device of the single power module based at least on the current and the reference temperature,
   calculating a first accumulated fatigue damage of the switching power converter based on the first single fatigue damage.
A2. Method according to clause A1, wherein the single power module comprises a second semiconductor device, the first semiconductor device and the second semiconductor device conducting currents of opposite sign, the method further comprising calculating a second single fatigue damage of the second semiconductor device based at least on the current and the reference temperature, and calculating a second accumulated fatigue damage of the switching power converter based on the second single fatigue damage.
A3. Method according to clause A1 or A2, wherein the single power module comprises a third semiconductor device (SW₂) paired with the first semiconductor device (D₁) to form a first switching pair comprising a first controllable switch and a second uncontrolled switch, wherein the first and the third semiconductor devices are connected in series, preferably wherein the first semiconductor device comprises the first uncontrolled switch.
A4. Method according to clauses A2 and A3 in conjunction, wherein the single power module comprises a fourth semiconductor device (SW₁) paired with the second semiconductor device (D₂) to form a second switching pair comprising a second controllable switch and a second uncontrolled switch, wherein the second and the fourth semiconductor devices are connected in series, wherein the first and the second switching pairs are configured to conduct corresponding currents of opposite sign, preferably wherein the second semiconductor device comprises the second uncontrolled switch.
A5. Method according to any one of the previous clauses, further comprising estimating a remaining lifetime based on a predetermined total lifetime of the switching power converter and the first, and optionally the second accumulated fatigue damage.
A6. Method according to any one of the previous clauses, wherein the first, optionally the second single fatigue damage is determined only in respect of the single power module of the plurality of power modules.
A7. Method according to any one of the previous clauses, further comprising storing at least one of the accumulated fatigue damage and the remaining lifetime in a local memory of the switching power converter.
A8. Method according to any one of the previous clauses, comprising measuring the reference temperature during operation of the switching power converter and for each power module of the plurality of power modules (114, 115), wherein determining the single power module comprises selecting of the plurality of power modules the power module associated with a highest one of the reference temperature measured.
A9. Method according to clause A8, wherein the reference temperature (T_{NTC}) is measured using a thermistor (116), preferably wherein the thermistor is incorporated in the corresponding power module of the plurality of power modules.
A10. Method according to any one of the previous clauses, wherein calculating the first single fatigue damage, optionally the second single fatigue damage comprises calculating a junction temperature of the first semiconductor device, optionally the second semiconductor device respectively.
A11. Method according to clause A10, wherein calculating the junction temperature comprises determining a power dissipation (P_{DISS}(t)) of the respective semiconductor device based on the current (Iₒᵤₜ) of the switching power converter, and optionally based on a duty cycle (D) of the single power module, preferably the current being determined by at least one of a measured current and a reference current of the switching power converter.
A12. Method according to clause A10 or A11, comprising determining a power dissipation of the single power module (P_{DISS,MODULE}(t)), wherein calculating the junction temperature comprises determining a case temperature (T_{C}(t)) of the single power module, preferably wherein the case temperature is determined based on the reference temperature of the single power module and the power dissipation of the single power module (P_{DISS,MODULE}(t)), preferably wherein the power dissipation of the single power module is determined based on the current (Iₒᵤₜ) of the switching power converter and optionally a duty cycle (D) of the single power module, preferably the current being determined by at least one of a measured current and a reference current of the switching power converter.
A13. Method according to any one of the clauses A10 to A12, further comprising comparing the junction temperature to a pre-defined junction temperature threshold, preferably further comprising disabling the switching power converter in the event that the junction temperature exceeds the pre-defined junction temperature threshold.
A14. Method according to any one of the previous clauses, wherein the first semiconductor device, optionally the second semiconductor device is an uncontrolled switch, preferably a diode.
A15. Switching power converter (100) comprising a plurality of power modules (114, 115), each comprising a first semiconductor device (D₁) and a processing unit (140), wherein the processing unit is configured for performing the method of any one of the previous clauses.
A16. Switching power converter according to clause A15, wherein each of the plurality of power modules (114) comprises a single base plate (10) on which all of the at least one first semiconductor device of the respective power module are arranged.
A17. Switching power converter according to clause A15 or A16, further comprising a memory module (310) configured for storing the first, optionally the second accumulated fatigue damage, optionally the remaining lifetime.
A18. Amplifier system comprising a plurality of the switching power converters of any one of the clauses A15 to A17 and an array of electrical connectors configured to connect individual ones of the plurality of switching power converters, wherein the plurality of the switching power converters are configured as amplifiers, wherein at least one of the plurality of switching power converters is field replaceable.
A19. Amplifier system according to clause A18, further comprising a processing unit configured to process at least one of the accumulated fatigue damage and the remaining lifetime of the plurality of switching power converters.
A20. Amplifier system (600) according to clause A18 or A19, wherein the plurality of switching power converters (611, 612, 613) are configured for driving gradient coils (621, 622, 623).
A21. Magnetic Resonance Imaging system, comprising at least one of a switching power converter of any one of the clauses A15 to A17 or an amplifier system of any one of clauses A18 to A20.

1. A method for estimating an accumulated fatigue damage of a switching power converter (100), the switching power converter comprising a plurality of power modules (114, 115) each comprising a first semiconductor device (SW₁, D₁, SW₂, D₂), the method comprising:
determining, of the plurality of power modules, a single power module having the first semiconductor device being thermally most heavily stressed,
measuring, while operating the switching power converter, a reference temperature (T_{NTC}) related to a temperature of at least the single power module,
determining a current (Iₒᵤₜ) of the switching power converter,
calculating a first single fatigue damage of the first semiconductor device of the single power module based at least on the current and the reference temperature, wherein the first single fatigue damage is determined only in respect of the single power module of the plurality of power modules, and
calculating a first accumulated fatigue damage of the switching power converter based on the first single fatigue damage.

2. The method according to claim 1, wherein the single power module comprises a second semiconductor device, the first semiconductor device and the second semiconductor device conducting currents of opposite sign, the method further comprising:
calculating a second single fatigue damage of the second semiconductor device based at least on the current and the reference temperature, wherein the second single fatigue damage is determined only in respect of the single power module of the plurality of power modules, and
calculating a second accumulated fatigue damage of the switching power converter based on the second single fatigue damage.

3. The method according to claim 1, wherein the single power module comprises a third semiconductor device (SW₂) paired with the first semiconductor device (D₁) to form a first switching pair of a first controllable switch and a second uncontrolled switch, wherein the first and the third semiconductor devices are connected in series.

4. The method according to claim 2, wherein the single power module comprises a third semiconductor device (SW₂) paired with the first semiconductor device (D₁) to form a first switching pair of a first controllable switch and a second uncontrolled switch, wherein the first and the third semiconductor devices are connected in series, wherein the single power module comprises a fourth semiconductor device (SW₁) paired with the second semiconductor device (D₂) to form a second switching pair of a second controllable switch and a second uncontrolled switch, wherein the second and the fourth semiconductor devices are connected in series, wherein the first and the second switching pairs are configured to conduct corresponding currents of opposite sign.

5. The method according to claim 1, further comprising estimating a remaining lifetime based on a predetermined total lifetime of the switching power converter and the first accumulated fatigue damage.

6. The method according to claim 1, further comprising storing at least one of the accumulated fatigue damage and the remaining lifetime in a local memory of the switching power converter.

7. The method according to claim 1, wherein determining the single power module comprises measuring the reference temperature for each power module of the plurality of power modules while operating the switching power converter and selecting of the plurality of power modules the power module associated with a highest one of the reference temperature measured.

8. The method according to claim 7, wherein measuring the reference temperature (T_{NTC}) comprises utilizing a thermistor (116) incorporated in the corresponding power module of the plurality of power modules.

9. The method according to claim 1, wherein calculating the first single fatigue damage comprises calculating a junction temperature of the first semiconductor device.

10. The method according to claim 9, wherein calculating the junction temperature comprises determining a power dissipation (P_{DISS}(t)) of the respective semiconductor device based on the current (Iₒᵤₜ) of the switching power converter.

11. The method according to claim 9, further comprising determining a power dissipation of the single power module (P_{DISS,MODULE}(t)), wherein calculating the junction temperature comprises determining a case temperature (T_{C}(t)) of the single power module.

12. The method according to claim 9, further comprising comparing the junction temperature to a pre-defined junction temperature threshold.

13. The method according to claim 1, wherein the first semiconductor device is an uncontrolled switch.

14. A switching power converter (100) comprising a plurality of power modules (114, 115), each of the plurality of power modules comprising a first semiconductor device (D₁), wherein the switching power converter comprises a processing unit (140) configured to perform the method of claim 1.

15. The switching power converter according to claim 14, wherein each of the plurality of power modules (114) comprises a single base plate (10) on which the first semiconductor device of the respective power module is arranged.

16. The switching power converter according to claim 14, further comprising a memory module (310) configured to store the first accumulated fatigue damage.

17. An amplifier system comprising a plurality of the switching power converters of claim 14 and an array of electrical connectors configured to connect individual ones of the plurality of switching power converters, wherein the plurality of the switching power converters are configured as amplifiers, wherein at least one of the plurality of switching power converters is field replaceable.

18. The amplifier system according to claim 17, further comprising a processing unit configured to process at least one of the accumulated fatigue damage and the remaining lifetime of the plurality of switching power converters.

19. The amplifier system (610) according to claim 17, wherein the plurality of switching power converters (611, 612, 613) are configured to drive gradient coils (621, 622, 623).

20. A Magnetic Resonance Imaging system (600), comprising the switching power converter of claim 14.
